(19) United States
(12) Patent Application Publication
(10) Pub. No.: US 2025/0342271 A1
(43) Pub. Date: Nov. 6, 2025

(54) FRAMEWORK FOR ASYMMETRIC PRIVATE SET INTERSECTION MATCHING

(71) Applicants: Lemon Inc., Grand Cayman (KY); Beijing Zitiao Network Technology Co., Ltd., Beijing (CN)

(72) Inventors: Chuyuan Chen, Shanghai (CN); Brendon Lim Chee How, Singapore (SG); Yongchuan Niu, Beijing (CN); Li Wang, Beijing (CN); Qiang Yan, Shanghai (CN)

(21) Appl. No.: 18/919,944

(22) Filed: Oct. 18, 2024

Related U.S. Application Data
(63) Continuation of application No. PCT/CN2024/091085, filed on May 3, 2024.

(51) Int. Cl. G06F 21/62

(52) U.S. Cl. CPC G06F 21/6227; G06F 21/6272

(57) ABSTRACT

A server computer is programmed to: generate a first plurality of encrypted records partitioned into groups, each including encrypted records whose corresponding input records share a prefix; receive, from a client device, a second plurality of encrypted records, each accompanied by a prefix; encrypt the second plurality of encrypted records to create a second plurality of doubly encrypted records, query, using the prefix, a data warehouse to fetch a group of encrypted records; generate a data structure encoded to indicate a presence of each encrypted record of the group fetched from the data warehouse; and transmit the second plurality of doubly encrypted records and the data structure to the second device, the second device using the second plurality of doubly encrypted records and the data structure to determine whether at least one of the second plurality of encrypted records is included in one group of encrypted records.

### CLAIM OF PRIORITY

This application is a continuation of, and claims priority to International Application No. PCT/CN2024/091085, filed May 3, 2024, the contents of which are incorporated herein by reference in their entirety.

### TECHNICAL FIELD

This specification generally relates to protecting data privacy of parties during online communication sessions.

### BACKGROUND

A content sharing platform can connect its users by presenting the users with a selection of their existing address book contacts who are registered with the content sharing platform. For example, the content sharing platform can provide a messaging application installed on a user device such as a mobile phone. The user of the user device may allow the messaging application to access the contacts stored on the user device. This convenient feature may also be known as mobile contact discovery, which attempts to match users' contact lists with the service's database. The address book of each user can also be checked regularly to provide an up-to-date list of possible contacts. However, some contact discovery implementations may put the users' privacy at risk. For example, some implementations were found to obtain their users' contact lists in plaintext. For those implementations that use hashing-based encryptions, these implementations are vulnerable to brute-force attacks.

### SUMMARY

In one aspect, some implementations provide a computer-implemented method that includes: processing, at one or more first devices and using a first encryption key generated for the one or more first devices, a first plurality of input records to generate a first plurality of encrypted records partitioned into a plurality of groups, each group including one or more encrypted records having a group prefix, each group of encrypted records stored on a data repository and keyed using the group prefix; receiving, from a second device, a second plurality of encrypted records, each encrypted based on a second encryption key generated for the second device, and accompanied by a prefix provided by the second device: encrypting the second plurality of encrypted records based on the first encryption key to create a second plurality of doubly encrypted records; querying, using the prefix provided by the second device as a database key, the data repository to fetch a group of encrypted records; generating a data structure encoded to indicate a presence of each encrypted record of the group of encrypted records fetched from the data repository; and transmitting the second plurality of doubly encrypted records and the data structure to the second device, the second device using the second plurality of doubly encrypted records and the data structure to determine whether at least one of the second plurality of encrypted records is included in one group of the plurality of groups of encrypted records.

Implementations may include one or more of the following features.

The data repository may include: one or more databases configured to conduct transactions using an append-only file persistence mechanism. The method may further include: capturing live updates to the first plurality of input records using at least one data pipeline coupled to the one or more databases of the data repository, wherein the at least one data pipeline is driven by a distributed publish-subscribe messaging protocol. The method may further include: streaming the live updates to the one or more databases at the data repository via the at least one data pipeline. The method may further include: incorporating information from at least one offline database by executing one or more batch jobs to backfill the one or more databases of the data repository based on the information from the at least one offline database. The method may further include: responsive to a portion of the information from the at least one offline database being invalid, transmitting an alert to the at least one offline database without incorporating the portion of the information in the one or more databases of the data repository. Each input record may be hashed using a hashing algorithm. The data structure may include a bloom filter.

In another aspect, some implementations provide one or more computer-readable storage media encoded with instructions that, when executed by one or more computers, cause the one or more computers to perform operations comprising: processing, at one or more first devices and using a first encryption key generated for the one or more first devices, a first plurality of input records to generate a first plurality of encrypted records partitioned into a plurality of groups, each group including one or more encrypted records having a group prefix, each group of encrypted records stored on a data repository and keyed using the group prefix; receiving, from a second device, a second plurality of encrypted records, each encrypted based on a second encryption key generated for the second device, and accompanied by a prefix provided by the second device: encrypting the second plurality of encrypted records based on the first encryption key to create a second plurality of doubly encrypted records; querying, using the prefix provided by the second device as a database key, the data repository to fetch a group of encrypted records; generating a data structure encoded to indicate a presence of each encrypted record of the group of encrypted records fetched from the data repository; and transmitting the second plurality of doubly encrypted records and the data structure to the second device, the second device using the second plurality of doubly encrypted records and the data structure to determine whether at least one of the second plurality of encrypted records is included in one group of the plurality of groups of encrypted records.

Implementations may include one or more of the following features.

The data repository may include: one or more databases configured to conduct transactions using an append-only file persistence mechanism. The operations may further include: capturing live updates to the first plurality of input records using at least one data pipeline coupled to the one or more databases of the data repository, wherein the at least one data pipeline is driven by a distributed publish-subscribe messaging protocol. The operations may further include: streaming the live updates to the one or more databases at the data repository via the at least one data pipeline. The operations may further include: incorporating information from at least one offline database by executing one or more batch jobs to backfill the one or more databases of the data repository based on the information from the at least one offline database. The operations may further include: responsive to a portion of the information from the at least one offline database being invalid, transmitting an alert to the at least one offline database without incorporating the portion of the information in the one or more databases of the data repository. Each input record may be hashed using a hashing algorithm. The data structure may include a bloom filter.

In yet another aspect, some implementations provide a computer system comprising one or more computer processors configured to perform operations comprising: processing, at one or more first devices and using a first encryption key generated for the one or more first devices, a first plurality of input records to generate a first plurality of encrypted records partitioned into a plurality of groups, each group including one or more encrypted records having a group prefix, each group of encrypted records stored on a data repository and keyed using the group prefix; receiving, from a second device, a second plurality of encrypted records, each encrypted based on a second encryption key generated for the second device, and accompanied by a prefix provided by the second device: encrypting the second plurality of encrypted records based on the first encryption key to create a second plurality of doubly encrypted records; querying, using the prefix provided by the second device as a database key, the data repository to fetch a group of encrypted records; generating a data structure encoded to indicate a presence of each encrypted record of the group of encrypted records fetched from the data repository; and transmitting the second plurality of doubly encrypted records and the data structure to the second device, the second device using the second plurality of doubly encrypted records and the data structure to determine whether at least one of the second plurality of encrypted records is included in one group of the plurality of groups of encrypted records.

Implementations may include one or more of the following features.

The data repository may include: one or more databases configured to conduct transactions using an append-only file persistence mechanism. The operations may further include: capturing live updates to the first plurality of input records using at least one data pipeline coupled to the one or more databases of the data repository, wherein the at least one data pipeline is driven by a distributed publish-subscribe messaging protocol. The operations may further include: streaming the live updates to the one or more databases at the data repository via the at least one data pipeline. The operations may further include: incorporating information from at least one offline database by executing one or more batch jobs to backfill the one or more databases of the data repository based on the information from the at least one offline database. The operations may further include: responsive to a portion of the information from the at least one offline database being invalid, transmitting an alert to the at least one offline database without incorporating the portion of the information in the one or more databases of the data repository. Each input record may be hashed using a hashing algorithm. The data structure may include a bloom filter

The subject matter described in this specification can be implemented in particular embodiments so as to realize one or more of the following advantages. First, some implementations leverage multiple layers of encryption including, for example, Secure Hash Algorithm 256-bit (SHA256) encryption, client-specific secret keys, and server-specific secret keys to prevent the exposure of sensitive contact details during transmission and storage. The multiple layers of encryption are instrumental to achieving asymmetric private set intersection (PSI) matching in real-time communication between a user device and a remote system (e.g., a server computer) for handling real-world databases on the system that store records for very large numbers (e.g., hundreds of millions, billions, or more) of registered users. Second, some implementations also incorporate probabilistic data structures to provide approximate answers, rather than exact answers based on an exhaustive search of the full record. The probabilistic data structure can improve computational speed and reduce storage overhead with no compromise to the computational output. Third, some implementations incorporate bucketization techniques streamline data communication so that queries can be handled with reduced storage and communication overhead, thus improving the operation of the underlying communication network. For example, some implementations incorporate a data preparation protocol to maintain data integrity, accuracy, and security, thereby supporting a seamless and reliable asymmetric PSI matching operation.

The details of one or more implementations of the subject matter of this specification are set forth in the description, the claims, and the accompanying drawings. Other features, aspects, and advantages of the subject matter will become apparent from the description, the claims, and the accompanying drawings.

### BRIEF DESCRIPTION OF DRAWINGS

FIG. 1 illustrates an example of a workflow diagram between a user device and a server computer.

FIG. 2 illustrates an example of capturing live updates to records for incorporation into a database in communication with the server computer.

FIG. 3 illustrates an example of backfilling the database of FIG. 2 with information from an offline database.

FIG. 4 illustrates an example of partitioning encrypted records according to a prefix for each encrypted record.

FIGS. 5A and 5B illustrate a flow chart of an example process on a server computer to process data records and generate a data structure.

FIG. 6 is a block diagram illustrating an example of a computer system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The disclosed technology is directed to protecting data privacy on various online platforms, e.g., for social networking, e-commerce, or relationship management. For example, during contact discovery, the messaging apps (e.g., mobile apps on user devices), through the content sharing platform (e.g., the server providing the platform service), can help users identify existing contacts of the user that have created accounts on the same service offered by the social media platform. Such contact discovery may leak sensitive information in that the server may obtain contact information held by the user device while the user may glean information of other users who signed up for the service. The implementations of the present specification address the technical challenges arising under asymmetric private set intersection (PSI) matching in scenarios where party has a small amount of data and the other possesses a vast amount of quantity, with a need to match and find intersections. This technical challenge is deeply rooted in computerized technology used in social networking services where users aim to find friends, e-commerce platforms where sellers seek to match products, or even scientific research where researchers strive to identify common patterns.

The disclosed technology addresses the technical challenge of protecting data privacy that is unique to a modern platform digitally interconnecting an overwhelming number of registered users. Specifically, implementations of the disclosed technology allow for asymmetric PSI matching to enable mobile private contact discovery by designing cryptography and probabilistic data structures that strike a tradeoff between security and performance, thereby handling real-world databases that store records for large numbers (e.g., hundreds of millions, billions, or more) of registered users.

The disclosed technology includes the following salient features as part of a solution to the technical challenge. These salient features improve the operation of the underlying computing and communication infrastructure. Some implementations may leverage multiple layers of encryption including, for example, Secure Hash Algorithm 256-bit (SHA256) encryption, client-specific secret keys, and server-specific secret keys to prevent the exposure of sensitive contact details during transmission and storage. Such implementations may incorporate an oblivious pseudorandom function (OPRF) in a two-party real-time communication protocol for computing the output of a pseudorandom function (PRF) in which one party (e.g., a server) holds the PRF secret key, and the other party (e.g., a client) holds the PRF input so that the server does not learn the actual contents of the client's input while the client does not learn about the actual contents of the server's PRF key. For example, the implementations may use elliptic curve diffie-hellman (ECDH)-based oblivious pseudorandom function, which a cryptographic protocol that combines the principles of oblivious pseudorandom functions (OPRFs) with the security properties of elliptic curve diffie-hellman (ECDH) key exchange.

Some implementations described in this specification also incorporate probabilistic data structures that provide approximate answers to queries about a large dataset, rather than exact answers. By incorporating a probabilistic data structure to test whether an element is a member of a set, exemplary implementations can handle large amounts of data in real-time and achieve a practical trade-off between accuracy and efficiency (e.g., as measured in computation time and storage space). Examples of the probabilistic data structure include a bloom Filter, a cuckoo Filter, to detect if an element is included a certain set where the false positive rate (FPR) and the false negative rate (FNR) are statistically negligible. For example, by incorporating a bloom filter, the exemplary implementations can provide an efficient method for the server to check for potential contact matches within its database while maintaining data obscurity. The bloom filter allows the search and retrieval process to be conducted without revealing the underlying encrypted elements, ensuring that only the presence or absence of data is communicated.

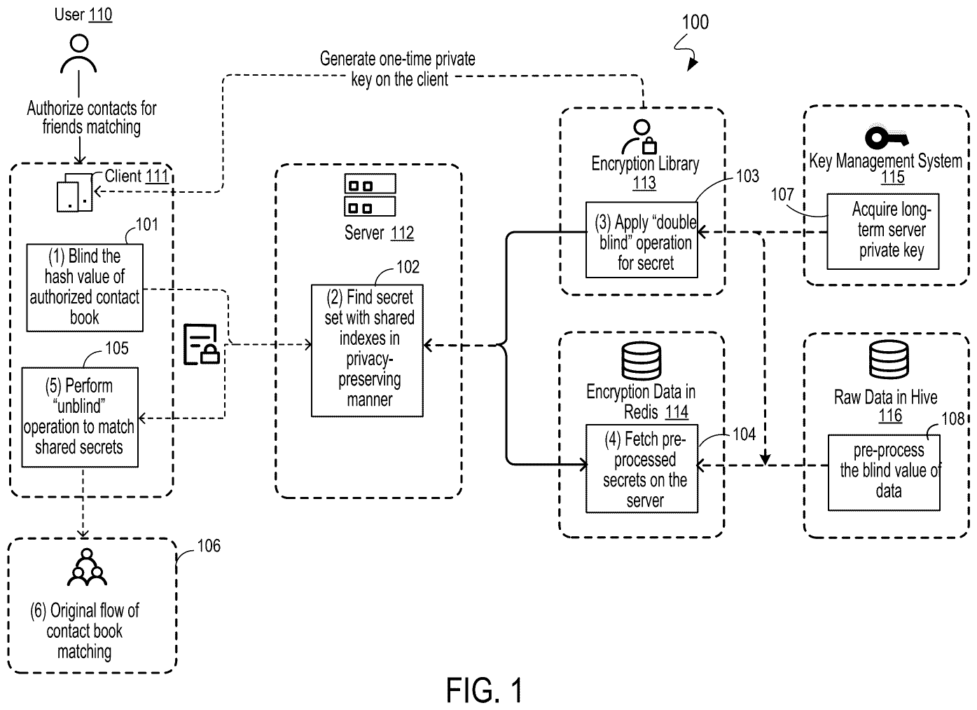

Further, some implementations employ bucketization techniques to group encrypted records with the same hash prefix into the same bucket so that only relevant buckets with hash prefixes matching a client inquiry need to be included in subsequent computations and communications. The use of hash prefixes as a database key can further optimize the lookup process by allowing the server to identify possible matches without the need to access or compare the full encrypted contacts, thereby reducing the computational burden and enhances performance, particularly when dealing with large datasets. On this note, the exemplary implementations employ databases such as Redis databases that operate to use append-only file persistence mechanism to enforce data durability, while providing fast read access for database transactions (e.g., fetching matching records). Here, the disclosed technology employs a data preparation protocol that is instrumental to maintain data integrity, accuracy, and security, thereby supporting a seamless and reliable PSI matching operation that can handle extensive data sets without compromise. The data preparation protocol encompasses the management of two distinct data streams, namely, incremental update from online data sources and bulk transfer from offline data sources. Some implementations prioritize the integration of incremental data into the data warehouse, followed by the incorporation of existing data from offline data sources to account for the lag during data backfill processes and to address potential data modifications that may occur in the interim. More details of these salient features are provided below with references to FIGS. 1 through 6.

FIG. 1 illustrates diagram 100 depicting an example of a workflow diagram between a user 110 on a client device 111 and a server computer 112. Although FIG. 1 provides an example of a device-server architecture, other architectures can be used to implement the technologies described in this specification. For example, the server computer 112 can be one or more first devices. In addition to a single server computer, the second device can be as system that includes multiple computers, multiple servers, or other communicatively coupled computing devices including distributed and cloud-based computing devices. The client device 111 can be a second device corresponding to a computer, mobile phone, tablet or other computing device.

As illustrated, the user 110 can authorize contacts of the user for friend matching on a digital platform such as, for example, a content sharing service, an e-commerce site, or an online community. In other words, the client device 111 has a stored list of contacts in which some contacts may have already signed up for service on the digital platform. Using a friending-finding feature, the user 110 may identify whether a contact of the user is already a registered user on the digital platform.

Client device 111 is equipped with a first key, e.g., key c. The first key can be generated by the client device 111 or obtained from another source, such as an encryption library 113. As illustrated in FIG. 1, the encryption library 113 generates a one-time private key on client device 111. In some implementations, key a can be an elliptic curve key. Other forms of encryption can also be used, such as, for example, RSA (Rivest-Shamir-Adleman) keys. The client device 111 also holds first records {x}, j=1, . . . , m. The records can be, for example, contact records, such as phone contact records, email contact records, nickname records, and hashtag records. The records are private records of the client device 111, the contents of the private records may not be shared with a third-party including, for example, the server computer 112 even though the server computer 112 and the client device 111 are openly communicating through an open channel, for example, when the user 110 on the client device 111 launches a messaging app to share video with other users on the digital platform involving the server computer 112. By way of illustration, the private records have been hashed to a uniform bit length (e.g., 256-bit length) using a hash function (e.g., Secure Hash Algorithm 256-bit, also known as SHA-256).

As illustrated, the client device 111 performs a blind operation on the hash value of authorized contact book (101). The bind operation encrypts the hashed values of each contact into an encrypted record. For a given cryptographic hash function. H, and the key c, the user device can encrypt the records {xⱼ}, j=1, . . . , m to generate encrypted records {H(xⱼ)^{c}}, j=1, . . . , m, along with the corresponding hash prefixes. In this notation, the cryptographic hash function first hashes the record to obtain hash(x) and then encrypts each hashed record using key c, which generates a ciphertext, i.e., a bit string of what appears to be a random and indecipherable string of bit values. The client device 111 then submits the encrypted records, along with the hash prefix of each contact (e.g., the leading four bits of the hash value) to the server computer 112. In the illustrated client-server architecture of FIG. 1, when the client device 111 communicates with the server computer 112, the server computer 112 may distribute tasks or computations among the available computational resources based on factors like resource availability, workload balancing, and optimization objectives. Examples of distributed computing scenarios can include distributed data processing, distributed storage systems, and distributed computing clusters. In an example of distributed processing, large volumes of data are processed across multiple computing nodes or servers simultaneously, which generally involves parallelization of data processing tasks to allow for faster data analysis, querying, and computation. In another example of distributed storage systems, the server computer 112 may replicate and distribute data across multiple storage nodes to allow for fault tolerance, scalability, and high availability. Here, data is typically partitioned and distributed across the storage nodes, and redundancy mechanisms such as replication or erasure coding are employed to protect against data loss. Examples of distributed computing clusters may include interconnected computing nodes on an inter-node high-speed network to execute computational tasks in parallel.

As illustrated in FIG. 1, the server computer 112 identifies, in a privacy-preserving manner, a group of encrypted records on the server-side that share the client-provided hash prefix (102). The server computer 112 is equipped with a second key, e.g., key s. The second key can be generated by the server computer 112 or obtained from another source such as encryption library 113, which acquires key s from key management system 115 (107). In some implementations, key s can also be an elliptic curve key (e.g., based on an elliptic curve different than the one used by the client device 111).

For example, the server computer 112 may apply a “double blind” operation to encrypt the client-provided encrypted records using key s to generate doubly encrypted records (103). For example, server computer 112 may encrypt client-encrypted record {H(xⱼ)^{c}} using server key s to generate doubly encrypted record {(H(xⱼ)^{c})^{s}}. This operation may also be known as the “double blind” operation.

Using the client-provided prefix for a given encrypted record, the server computer 112 queries a data warehouse (e.g., housing a Redis database 114) to fetch a group of encrypted records (i.e., encrypted using server key s) whose input records share the same hash-value prefix, as provided by the client (104). In other words, the server computer 112 applies the client-provided prefix as a database key to retrieve encrypted records that have been pre-stored in the data warehouse on the server-side. In particular, some implementations leverage the hash-prefix, which refers to the first n prefix bits of the hash value. Notably, the value of n (prefix bit length) can be adjusted as a tradeoff between privacy and efficiency. For example, server computer 112 may use a given hash prefix to obtain a group (also known as a bucket) of encrypted records with the matching prefix from the data warehouse (also known as a data repository).

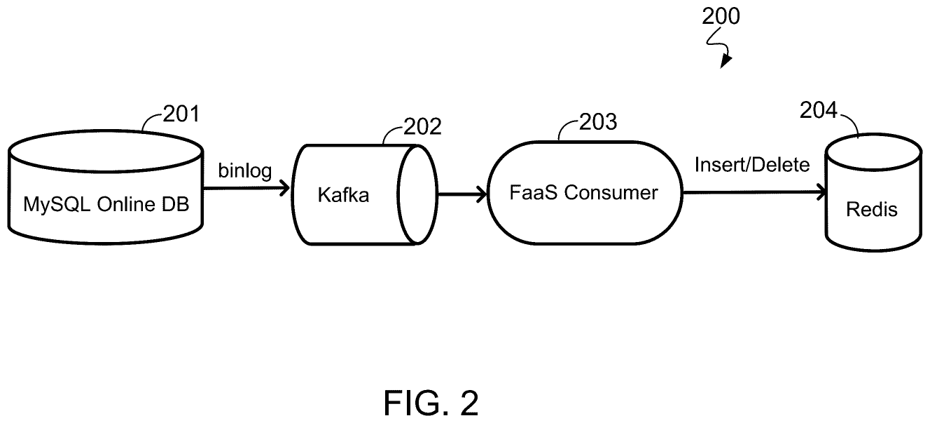

As illustrated, the data warehouse also hosts the raw data (e.g., hashed but not encrypted) so that the data warehouse pre-processes the raw data in accordance with the disclosed technology (108), as further explained below with references to FIGS. 2-4. In the illustrated example, the data warehouse operates a structured database (include SQL databases for tables with rows and columns) managed, e.g., by Apache Hive (116), which is built on top of Hadoop and is designed to facilitate querying and analyzing large datasets stored in Hadoop's distributed storage file system (also known as HDFS), or other compatible file systems.

Within the framework for asymmetric Private Set Intersection (PSI) matching, the disclosed technology incorporates features to improve preparation of the datasets stored in the data warehouse to optimize operational efficiency and data integrity. In fact, the disclosed technology can maintain data consistency and correctness for data transactions on a scale of billions, tens of billions or even more data records. The salient features include data preparation and data bucketization, both of which can facilitate seamless and reliable private set intersection matching.

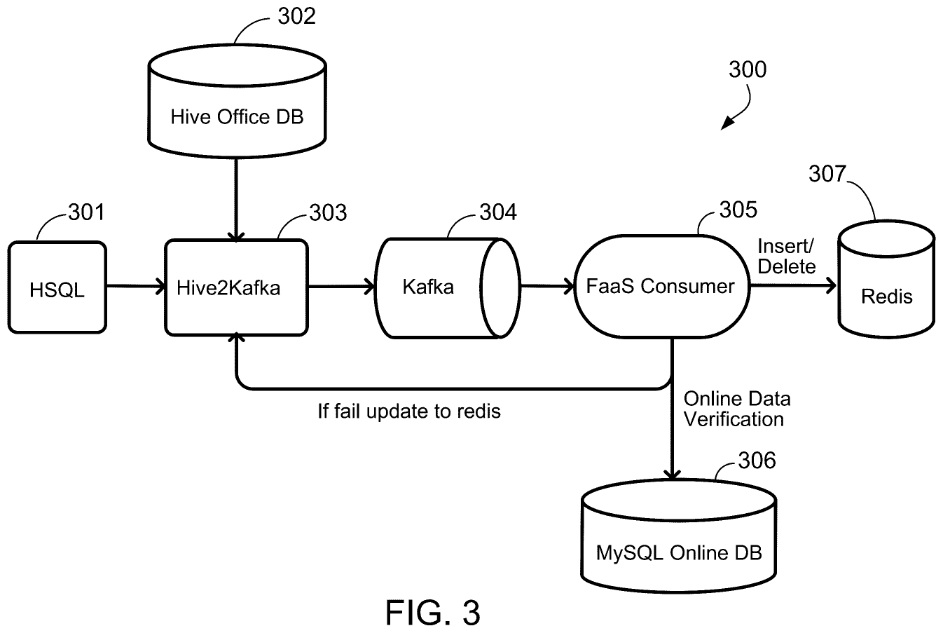

Referring to FIGS. 2-3, the data preparation protocol of the disclosed technology encompasses the management of two distinct data streams, namely, incremental updates from online data sources, and bulk transfers from offline data sources. In some implementations, the data preparation protocol prioritizes the integration of incremental data updates into the data warehouse, followed by the incorporation of bulk data transfers, the latter of which can occur in the background through batch processing jobs. This sequential processing can account for the lag during data backfill processes for bulk data transfer and address potential data modifications that may occur during the backfill processes. Significantly, capturing live changes to the data can improve the quality of data hosted by the data warehouse so that the databases reflect the most up-to-date and accurate information at a given moment.

As illustrated in diagram 200 of FIG. 2, some implementations can establish real-time transfer functions to process logged events from an online database as changes occur in the data records of the online database. The online database can store a structured table with rows and columns where data transactions can be conducted using structured query language (SQL) or SQL-like language. Diagram 200 depicts a MySQL online database 20 with binary logging (binlog) enabled. In this example, binary logging records changes to the table data stored in the MySQL database such as inserts, updates, and deletes in the form of binlog events. A data pipeline 202 implemented on a distributed streaming platform (e.g., Kafka) is connected to binary logging of MySQL online database 201 to receive the binlog events. The Kafka example provides a distributed publish-subscribe messaging model to allow streaming of data (e.g., binlog events) in real-time between MySQL online database 201 and a function as a service (FaaS) consumer 203. The FaaS consumer 203 receives the data feed provided by the binlog events of MySQL online database 201 as the logged events are published. The FaaS consumer 203 can be implemented as an execution thread triggered on each incoming logged events to update data records on Redis database 204 (e.g., in the form of insert or delete data records), as the changes occur in the MySQL online database 201. The FaaS consumer 203 can scale automatically based on demand, which allows the configuration of FIG. 2 to handle large data volumes with minimal overhead and with no concern over infrastructure capacity.

The Redis database 204 is configured to conduct data transactions using an append-only file persistence mechanism to achieve data durability, while providing fast read access for doing data matching. In particular, the Redis database 204 handles append operations efficiently and provides various data structures and commands tailored to use cases such as lists, blocking operations, publish/subscribe application, and bit-level manipulation. For example, the Redis database 204 uses the list data structure that allows for efficient appending of elements at both the head and the tail of the list. Notably, the Redis database 204 conducts append operations to enforce atomicity. Here, when appending elements to a list, the Redis database 204 can ensures that the operation is atomic for the purpose of data transaction. In other words, the operation is performed as a single, indivisible unit, and no other operations can interrupt or interfere with the operation. Moreover, the Redis database 204 offers a Publish/Subscribe (Pub/Sub) mechanism, which allows clients to subscribe to channels and receive messages published to those channels. The Pub/Sub mechanism is aimed at appending messages to channels, which are then delivered to subscribers in real-time. The use of bloom filter incurs a minor error rate, which is generally less than 0.001.

As illustrated in diagram 300 of FIG. 3, some implementations handle bulk transfer from offline data sources through data backfill processes. Diagram 300 depicts HSQL (hyperSQL) database 301 and Hive offline database 302 coupled to an interface (i.e., Hive2Kafka) 303, which in turn feeds into a data pipeline (e.g., Kafka) 304. Here, HSQL 301 is a relational database management system that supports both in-memory and persistent modes of operation. Hive offline database 302 refers to an Apache Hive database system that is offline and arranged for batch processing of large volume of data. For background, Apache Hive is built on top of Hadoop to provide a mechanism to query and analyze large datasets stored in Hadoop's HDFS (Hadoop Distributed File System) using a language similar to SQL called HiveQL. Hive offline database 302 is configured to focus on batch processing and querying large datasets stored in HDFS. The interface 303 recasts, for example, Hive data from Hive database 302 to real-time streaming data to go through a data pipeline (Kafka) 304. As illustrated in FIG. 3, the data pipeline (Kafka) 304 feeds into a function as a service (FaaS) consumer 305, which can be implemented as an execution thread triggered on each incoming publishing event from the data pipeline 304 to update data records on Redis database 307 (e.g., in the form of insert or delete data records). As data is being backfilled from the Hive offline database 302, the backfilled data is cross-referenced with an online database (e.g., MySQL online database) 306 to verify consistency. In the event the online verification fails, the transaction to update Redis database 307 may not proceed. Meanwhile, a failure message is transmitted to the interface 303 to alert. for example, the database management system for offline database 302 that the error has occurred. In some cases, the cross-referencing process will keep running after the entire offline database has been backfilled, for example, on a daily basis to continue verification with the online database.

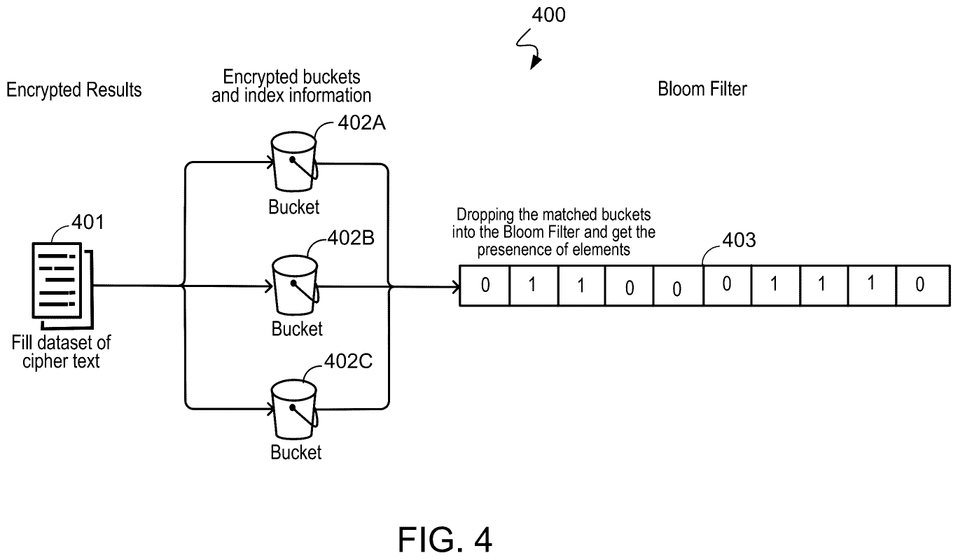

Referring to diagram 400 of FIG. 4, the disclosed technology also incorporates data bucketization to arrange data records in the data warehouse in a manner that facilitates seamless and reliable private set intersection matching. Specifically, some implementations asynchronously pre-process the contact data on the server-side, encrypt the data into cipher format and store the encrypted data into persistent storage to allow for efficient access by a client device. Instead of storing the full dataset of encrypted records (e.g., based on phone contact records hashed to a uniform bit length by SHA-256), the disclosed technology can group the full dataset 401 into a set of smaller groups (also known as buckets). For example, the full dataset of encrypted data records are divided into buckets 402A, 402B, and 402C, each bucket containing a subset of the encrypted records whose corresponding hashed phone contacts share the same leading bits (i.e., a shared prefix for the bucket). The leading bits can be the initial bytes of the hashed prefix of contacts. This bucketization technique enables partitioning extensive datasets into smaller subsets of entries with the same prefix, thereby reducing the amount of data that needs to be transmitted from the server-side to the client-side.

Moreover, diagram 400 illustrates preparing bloom filter 403 to encode a presence of each encrypted data record from a bucket. For context, the bloom filter 403 is a probabilistic data structure set up to provide the encoded presence of each encrypted data record so that, when the bloom filter is looked up using an encrypted data record, the bloom filter provides a binary answer for which the probability of providing false positive and false negative is negligibly small. Moreover, the risk of potential phone contact leakage through the disclosure of the shared prefix is negligible, because of the fact that billions of potential phone contacts can share the same prefix.

Significantly, the disclosed technology leverages the inherent structure of a probabilistic data structure (such as a bloom filter) to further reduce the bandwidth overhead of transferring large volumes of data. Using the disclosed technology, the server system inserts the encrypted data records into the probabilistic data structure on the server-side and return the probabilistic data structure back to the client-side as a response to a request from the client. The probabilistic data structure is particularly well-suited for scenarios of verify the presence of a data record in a set of data records. Notably, the false positive rate (FPR) of bloom filter can be preserved by restricting the optimal size as threshold to avoid saturated bloom filter. For example, assume each bucket contains 30 encrypted phone numbers. When the client device uploads 200 contacts for matching, the server-side can return 6000 encrypted phone numbers back. Each encrypted phone number occupies 64 bytes, so the the size of the communication between the client and the server is 0.38 MB. Using a bloom filter, the disclosed technology can only transfer the array of the bloom filter, so the size will be reduced to 80000*8 bit=0.0096 MB, where 80000 is the size of the array for the bloom filter.

Returning to FIG. 1, the server computer 112 assembles a probabilistic data structure, for example, a bloom filter, which can be structured as an array to encode the presence of each server-encrypted record. The probabilistic data structure can provide approximate answers, rather than exact answers, to queries about the presence of a record in a large data set (e.g., millions of records or more). The probabilistic data structure, such as the bloom filter, is designed to handle large amounts of data in real-time, by striking a tradeoff between accuracy (e.g., low incidence of false negative) and efficiency (e.g., computation time, and storage size). Some implementations leverage probabilistic data structures to test the presence of particular data, e.g., a client-encrypted record inside a set of server-encrypted records, with sufficient precision and real-time response. While the above implementations are described with respect to a bloom filter, other suitable probabilistic data structure can be used, for example, a Cuckoo filter.

The server computer 112 transmits to the client device 111 data including the doubly encrypted records (based on the encrypted records from the client device 111), as well as the probabilistic data structure (e.g., the bloom filter assembled by the server computer 112). When the client device 111 receives the data from the server computer 112, the client computer 111 performs an “unblind” operation on the doubly encrypted records using the client key c to reveal the encrypted records that remain encrypted with the server key s. The client device 111 then tests the presence of each encrypted record that remains encrypted with the server key s against the probabilistic data structure (e.g., the bloom filter) to determine whether each encrypted record that remains encrypted with the server key s is included in the group of encrypted records that the server computer 112 used to assembly the probabilistic data structure. In the event of a match, the client computer 111 identifies a match of a contact of the user 110 (106).

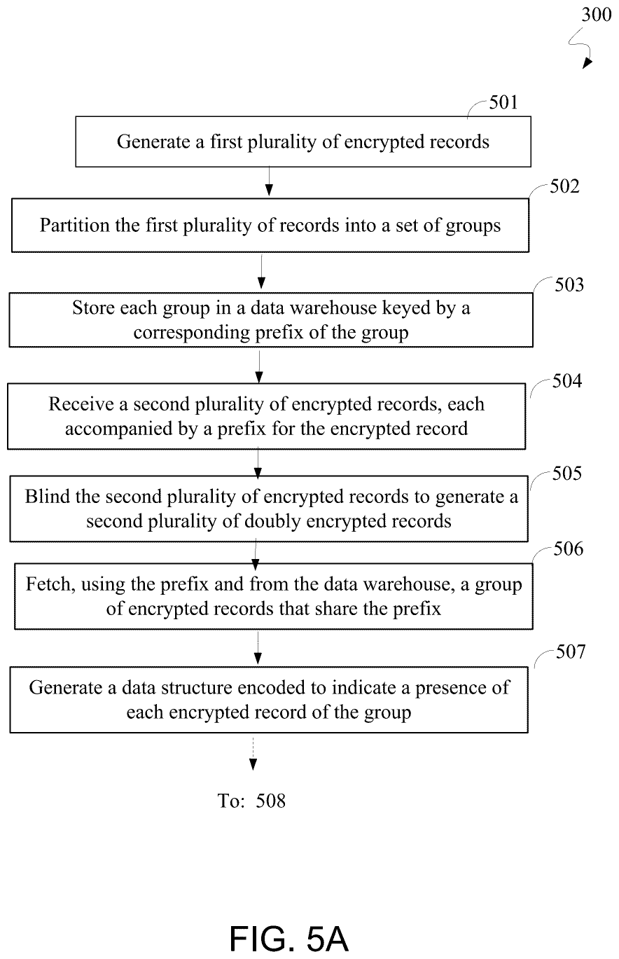

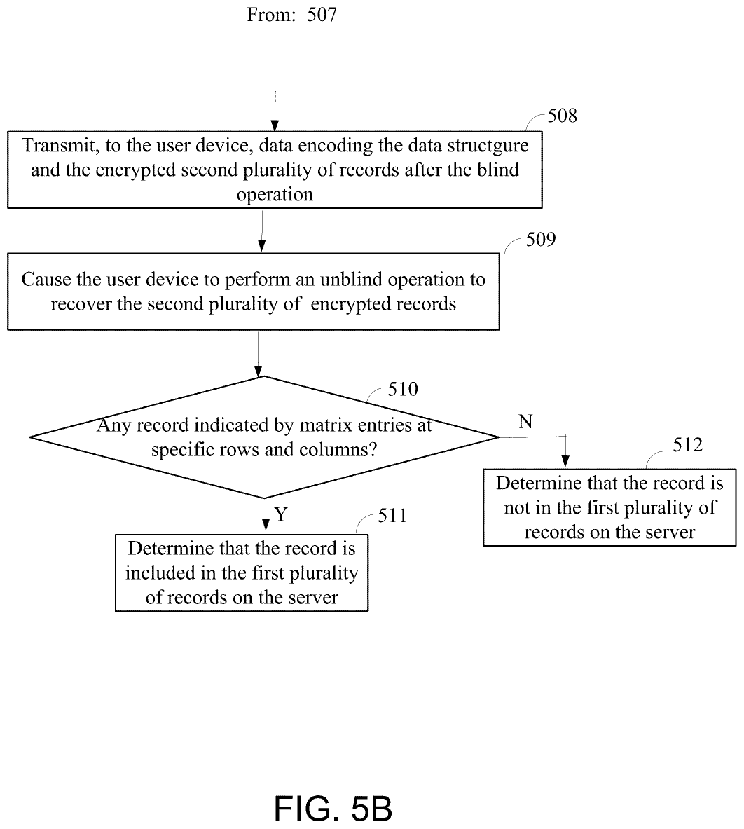

FIGS. 5A to 5B illustrate a flow chart of an example process 500 for asymmetric private set intersection matching in accordance with some implementations. For convenience, the process 500 will be described as being performed by a system of one or more computers, located in one or more locations, and programmed appropriately in accordance with this specification. For example, the system can include a server computer, e.g., the server computer 112 of FIG. 1, that when appropriately programmed, can perform the process 500.

The system encrypts a first plurality of data records on the server computer (501). For example, the data records may include a set of phone records of users who signed up for service by opening an account at, for example, a content sharing service, an e-commerce outlet, or a portal for academic researchers. The records may not be limited to phone records. The records can include other forms of contact records such as email addresses, nicknames, and hashtag identifications. In some implementations, the records are referred to as input records to connote the subsequent encryption. The input records may be hashed using a cryptographic hash function that projects the original records to a pre-determined bit length. Examples of the hash function may include Secure Hash Algorithm 256-bit (SHA256) that generates an output of 256-bit length. Additionally, or alternatively, the hash function may project each plain text data record to a uniform bit length of, for example, 64-bit, 128-bit, 512-bit, 1024-bit, 2048-bit, and so on. The encryption may apply a key generated at the server (e.g., server computer 112 in FIG. 1 that received the key from key management server 115). The key can be an elliptic curve key so that the encrypted data records can be computed as a series of outputs.

The system partitions the first plurality of encrypted records into a set of groups, also known as buckets (502). Each group in the set includes multiple encrypted records whose corresponding input records (e.g., hashed using SHA256) have a common prefix. The common prefix has a predetermined bit length of at least one bit. An example of the partitioning is provided in FIG. 4.

The system stores each group of encrypted records in a data warehouse where each group of encrypted records are keyed using the respective prefix (503). When queried using a key that matches the respective prefix, the data warehouse fetches the corresponding group of encrypted records. The technique is also known as bucketization, which allows for partitioning extensive datasets into smaller subsets of entries with the same prefix so that communication and storage overhead for handling the full set can be reduced.

The disclosed technology can improve process efficiency and maintain data integrity to achieve asymmetric private set intersection matching. As described above in association with FIGS. 2-3, the data preparation protocol at the data warehouse encompasses managing two distinct data streams: namely incremental live data from online sources and existing data from off-line sources. To maintaining database transactions at the data warehouse, the data preparation protocol generally prioritizes the integration of incremental data from online sources into one or more database at the data warehouse, followed by the incorporation of existing data from offline sources. The sequential tiered processing can account for the lag during data backfill processes for the offline data, which tend to voluminous, and to address potential data modifications that may occur in the interim. Capturing live changes to the underlying data records, for example, from online sources can provide the most current and hence, accurate, dataset from the databases of the data warehouse at a given moment.

The system receives, from a second device (e.g., client device 111), a request that provides a second plurality of encrypted records (504). Each encrypted record is encrypted based on a second key generated for the second device, accompanied by a prefix generated by the second device.

Responsive to the request, the system performs a blind operation to encrypt the second plurality of encrypted records based on a key of the system (505). The blind operation may encrypt the encrypted second plurality of records from a user device using a server key, which can also be an elliptic curve-based key. In this manner, the system generates a second plurality of doubly encrypted records. Additionally, the system fetches, using the prefix generated by the second device as a database key, a group of encrypted records from the data warehouse whose corresponding input records share the prefix (506). Moreover, the system generates a probabilistic data structure encoded to indicate a presence of each encrypted record from the fetched group of encrypted records (507). In some cases, the probabilistic data structure is inserted with binary entries at multiple positions in the probabilistic data structure so that the probability of these multiple positions in the probabilistic data structure to simultaneously provide a contrarian indication is negligibly small. More details of assembling the probabilistic data structure are provided above with reference to FIG. 4.

Turning to FIG. 5B, the system may transmit, to the second device, data encoding the probabilistic data structure and the doubly encrypted second plurality of data records (508). Here, after the blind operation on the server, the client-encrypted second plurality of data records are now encrypted using the server key, and hence doubly encrypted. Using the disclosed technology, the system can determine the ideal concurrency by executing data queries and cryptographic operations in parallel. Such simultaneous execution proves beneficial in terms of improving response times.

The system causes the user device, upon receipt of the data encoding the probabilistic data structure and the doubly encrypted second plurality of data records, performs an unblind operation to recover the client-encrypted second plurality of data records. The user device may then search the probabilistic data structure for indication of the presence of any of the client-encrypted second plurality of data records (509). As explained above with reference to FIG. 1, for a given record to be outside the data set on the server, the entries in the probabilistic data structure at corresponding positions need to contain at least one bit having a value of 1. The size of the matrix as well as the bit length of the encryption results are judiciously selected so that the probability of a false negative is within a pre-determined threshold. Here, in response to determining there is no bit 1 in the corresponding entries in the probabilistic data structure (510), the user device can determine that the data record is included in the first plurality of records on the server (511). In response to determining that there is at least one bit 1 in the corresponding matrix entries (510), the user device can determine that the data record on the user device is not included in the first plurality of records on the server (512).

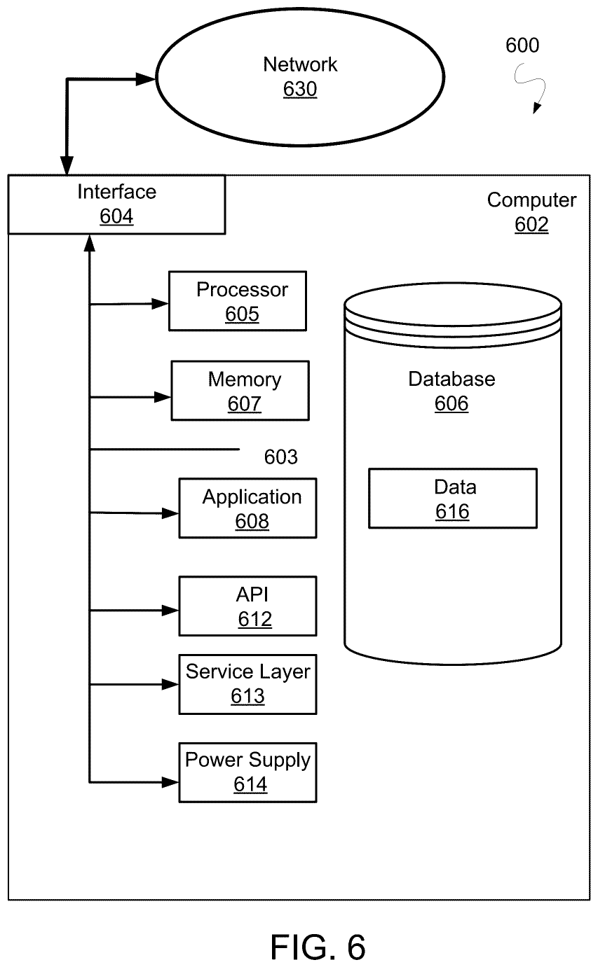

FIG. 6 is a block diagram illustrating an example of a computer system 600 used to provide computational functionalities associated with described algorithms, methods, functions, processes, flows, and procedures, according to an implementation of the present disclosure. The illustrated computer 602 is intended to encompass any computing device such as a server, desktop computer, laptop/notebook computer, wireless data port, smart phone, personal data assistant (PDA), tablet computing device, one or more processors within these devices, another computing device, or a combination of computing devices, including physical or virtual instances of the computing device, or a combination of physical or virtual instances of the computing device. Additionally, the computer 602 can comprise a computer that includes an input device, such as a keypad, keyboard, touch screen, another input device, or a combination of input devices that can accept user information, and an output device that conveys information associated with the operation of the computer 602, including digital data, visual, audio, another type of information, or a combination of types of information, on a graphical-type user interface (UI) (or GUI) or other UI.

The computer 602 can serve in a role in a computer system as a client, network component, a server, a database or another persistency, another role, or a combination of roles for performing the subject matter described in the present disclosure. The illustrated computer 602 is communicably coupled with a network 630. In some implementations, one or more components of the computer 602 can be configured to operate within an environment, including cloud-computing-based, local, global, another environment, or a combination of environments.

The computer 602 is an electronic computing device operable to receive, transmit, process, store, or manage data and information associated with the described subject matter. According to some implementations, the computer 602 can also include or be communicably coupled with a server, including an application server, e-mail server, web server, caching server, streaming data server, another server, or a combination of servers.

The computer 602 can receive requests over network 630 (for example, from a client software application executing on another computer 602) and respond to the received requests by processing the received requests using a software application or a combination of software applications. In addition, requests can also be sent to the computer 602 from internal users, external or third-parties, or other entities, individuals, systems, or computers.

Each of the components of the computer 602 can communicate using a system bus 603. In some implementations, any or all of the components of the computer 602, including hardware, software, or a combination of hardware and software, can interface over the system bus 603 using an application programming interface (API) 612, a service layer 613, or a combination of the API 612 and service layer 613. The API 612 can include specifications for routines, data structures, and object classes. The API 612 can be either computer-language independent or dependent and refer to a complete interface, a single function, or even a set of APIs. The service layer 613 provides software services to the computer 602 or other components (whether illustrated or not) that are communicably coupled to the computer 602. The functionality of the computer 602 can be accessible for all service consumers using this service layer. Software services, such as those provided by the service layer 613, provide reusable, defined functionalities through a defined interface. For example, the interface can be software written in JAVA, C++, another computing language, or a combination of computing languages providing data in extensible markup language (XML) format, another format, or a combination of formats. While illustrated as an integrated component of the computer 602, alternative implementations can illustrate the API 612 or the service layer 613 as stand-alone components in relation to other components of the computer 602 or other components (whether illustrated or not) that are communicably coupled to the computer 602. Moreover, any or all parts of the API 612 or the service layer 613 can be implemented as a child or a sub-module of another software module, enterprise application, or hardware module without departing from the scope of the present disclosure.

The computer 602 includes an interface 604. Although illustrated as a single interface 604 in FIG. 6, two or more interfaces 604 can be used according to particular needs, desires, or particular implementations of the computer 602. The interface 604 is used by the computer 602 for communicating with another computing system (whether illustrated or not) that is communicatively linked to the network 630 in a distributed environment. Generally, the interface 604 is operable to communicate with the network 630 and comprises logic encoded in software, hardware, or a combination of software and hardware. More specifically, the interface 604 can comprise software supporting one or more communication protocols associated with communications such that the network 630 or interface's hardware is operable to communicate physical signals within and outside of the illustrated computer 602.

The computer 602 includes a processor 605. Although illustrated as a single processor 605 in FIG. 6, two or more processors can be used according to particular needs, desires, or particular implementations of the computer 602. Generally, the processor 605 executes instructions and manipulates data to perform the operations of the computer 602 and any algorithms, methods, functions, processes, flows, and procedures as described in the present disclosure.

The computer 602 also includes a database 606 that can hold data for the computer 602, another component communicatively linked to the network 630 (whether illustrated or not), or a combination of the computer 602 and another component. For example, database 606 can be an in-memory, conventional, or another type of database storing data consistent with the present disclosure. In some implementations, database 606 can be a combination of two or more different database types (for example, a hybrid in-memory and conventional database) according to particular needs, desires, or particular implementations of the computer 602 and the described functionality. Although illustrated as a single database 606 in FIG. 6, two or more databases of similar or differing types can be used according to particular needs, desires, or particular implementations of the computer 602 and the described functionality. While database 606 is illustrated as an integral component of the computer 602, in alternative implementations, database 606 can be external to the computer 602. As illustrated, the database 606 holds the previously described data 616 including, for example, records held at data warehouse including Regis database 114 and Hive database 116 of FIG. 1.

The computer 602 also includes a memory 607 that can hold data for the computer 602, another component or components communicatively linked to the network 630 (whether illustrated or not), or a combination of the computer 602 and another component. Memory 607 can store any data consistent with the present disclosure. In some implementations, memory 607 can be a combination of two or more different types of memory (for example, a combination of semiconductor and magnetic storage) according to particular needs, desires, or particular implementations of the computer 602 and the described functionality. Although illustrated as a single memory 607 in FIG. 6, two or more memories 607 or similar or differing types can be used according to particular needs, desires, or particular implementations of the computer 602 and the described functionality. While memory 607 is illustrated as an integral component of the computer 602, in alternative implementations, memory 607 can be external to the computer 602.

The application 608 is an algorithmic software engine providing functionality according to particular needs, desires, or particular implementations of the computer 602, particularly with respect to functionality described in the present disclosure. For example, application 608 can serve as one or more components, modules, or applications. Further, although illustrated as a single application 608, the application 608 can be implemented as multiple applications 608 on the computer 602. In addition, although illustrated as integral to the computer 602, in alternative implementations, the application 608 can be external to the computer 602.

The computer 602 can also include a power supply 614. The power supply 614 can include a rechargeable or non-rechargeable battery that can be configured to be either user-or non-user-replaceable. In some implementations, the power supply 614 can include power-conversion or management circuits (including recharging, standby, or another power management functionality). In some implementations, the power-supply 614 can include a power plug to allow the computer 602 to be plugged into a wall socket or another power source to, for example, power the computer 602 or recharge a rechargeable battery.

There can be any number of computers 602 associated with, or external to, a computer system containing computer 602, each computer 602 communicating over network 630. Further, the term “client,” “user,” or other appropriate terminology can be used interchangeably, as appropriate, without departing from the scope of the present disclosure. Moreover, the present disclosure contemplates that many users can use one computer 602, or that one user can use multiple computers 602.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal, for example, a machine-generated electrical, optical, or electromagnetic signal that is generated to encode information for transmission to a receiver apparatus for execution by a data processing apparatus. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed.

The term “real-time,” “real time,” “realtime,” “real (fast) time (RFT),” “near(ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be, or further include special purpose logic circuitry, for example, a central processing unit (CPU), an FPGA (field programmable gate array), or an ASIC (application-specific integrated circuit). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with an operating system of some type, for example LINUX, UNIX, WINDOWS, MAC OS, ANDROID, IOS, another operating system, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and apparatus can also be implemented as, special purpose logic circuitry, for example, a CPU, an FPGA, or an ASIC.

Computers for the execution of a computer program can be based on general or special purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device.

Non-transitory computer-readable media for storing computer program instructions and data can include all forms of media and memory devices, magnetic devices, magneto optical disks, and optical memory device. Memory devices include semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Magnetic devices include, for example, tape, cartridges, cassettes, internal/removable disks. Optical memory devices include, for example, digital video disc (DVD), CD-ROM, DVD+/-R, DVD-RAM, DVD-ROM, HD-DVD, and BLURAY, and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity, a multi-touch screen using capacitive or electric sensing, or another type of touchscreen. Other types of devices can be used to interact with the user. For example, feedback provided to the user can be any form of sensory feedback. Input from the user can be received in any form, including acoustic, speech, or tactile input. In addition, a computer can interact with the user by sending documents to and receiving documents from a client computing device that is used by the user.

The term “graphical user interface,” or “GUI,” can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a plurality of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11 a/b/g/n or 802.20 (or a combination of 802.11x and 802.20 or other protocols consistent with the present disclosure), all or a portion of the Internet, another communication network, or a combination of communication networks. The communication network can communicate with, for example, Internet Protocol (IP) packets, Frame Relay frames, Asynchronous Transfer Mode (ATM) cells, voice, video, data, or other information between networks addresses.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what can be claimed, but rather as descriptions of features that can be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

Moreover, the separation or integration of various system modules and components in the previously described implementations should not be understood as requiring such separation or integration in all implementations, and it should be understood that the described program components and systems can generally be integrated together in a single software product or packaged into multiple software products.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method comprising:
processing, at one or more first devices and using a first encryption key generated for the one or more first devices, a first plurality of input records to generate a first plurality of encrypted records partitioned into a plurality of groups, each group including one or more encrypted records having a group prefix, each group of encrypted records stored on a data repository and keyed using the group prefix;
receiving, from a second device, a second plurality of encrypted records, each encrypted based on a second encryption key generated for the second device, and accompanied by a prefix provided by the second device:
encrypting the second plurality of encrypted records based on the first encryption key to create a second plurality of doubly encrypted records;
querying, using the prefix provided by the second device as a database key, the data repository to fetch a group of encrypted records;
generating a data structure encoded to indicate a presence of each encrypted record of the group of encrypted records fetched from the data repository; and
transmitting the second plurality of doubly encrypted records and the data structure to the second device, the second device using the second plurality of doubly encrypted records and the data structure to determine whether at least one of the second plurality of encrypted records is included in one group of the plurality of groups of encrypted records.

2. The computer-implemented method of claim 1, wherein the data repository comprises one or more databases configured to conduct transactions using an append-only file persistence mechanism.

3. The computer-implemented method of claim 2, further comprising:
capturing live updates to the first plurality of input records using at least one data pipeline coupled to the one or more databases of the data repository, wherein the at least one data pipeline is driven by a distributed publish-subscribe messaging protocol.

4. The computer-implemented method of claim 3, further comprising:
streaming the live updates to the one or more databases at the data repository via the at least one data pipeline.

5. The computer-implemented method of claim 3, further comprising:
incorporating information from at least one offline database by executing one or more batch jobs to backfill the one or more databases of the data repository based on the information from the at least one offline database.

6. The computer-implemented method of claim 5, further comprising:
responsive to a portion of the information from the at least one offline database being invalid, transmitting an alert to the at least one offline database without incorporating the portion of the information in the one or more databases of the data repository.

7. The computer-implemented method of claim 1, wherein each input record is hashed using a hashing algorithm, and
wherein the data structure comprises a bloom filter.

8. One or more computer-readable storage media encoded with instructions that, when executed by one or more computers, cause the one or more computers to perform operations comprising:
processing, using a first encryption key generated for the one or more computers, a first plurality of input records to generate a first plurality of encrypted records partitioned into a plurality of groups, each group including one or more encrypted records having a group prefix, each group of encrypted records stored on a data repository and keyed using the group prefix;
receiving, from a second device, a second plurality of encrypted records, each encrypted based on a second encryption key generated for the second device, and accompanied by a prefix provided by the second device:
encrypting the second plurality of encrypted records based on the first encryption key to create a second plurality of doubly encrypted records;
querying, using the prefix provided by the second device as a database key, the data repository to fetch a group of encrypted records;
generating a data structure encoded to indicate a presence of each encrypted record of the group of encrypted records fetched from the data repository; and
transmitting the second plurality of doubly encrypted records and the data structure to the second device, the second device using the second plurality of doubly encrypted records and the data structure to determine whether at least one of the second plurality of encrypted records is included in one group of the plurality of groups of encrypted records.

9. The one or more computer-readable storage media of claim 8, wherein the data repository comprises one or more databases configured to conduct transactions using an append-only file persistence mechanism.

10. The one or more computer-readable storage media of claim 9, wherein the operations further comprise:
capturing live updates to the first plurality of input records using at least one data pipeline coupled to the one or more databases of the data repository, wherein the at least one data pipeline is driven by a distributed publish-subscribe messaging protocol.

11. The one or more computer-readable storage media of claim 10, wherein the operations further comprise:
streaming the live updates to the one or more databases at the data repository via the at least one data pipeline.

12. The one or more computer-readable storage media of claim 10, wherein the operations further comprise:
incorporating information from at least one offline database by executing one or more batch jobs to backfill the one or more databases of the data repository based on the information from the at least one offline database.

13. The one or more computer-readable storage media of claim 12, wherein the operations further comprise:
responsive to a portion of the information from the at least one offline database being invalid, transmitting an alert to the at least one offline database without incorporating the portion of the information in the one or more databases of the data repository.

14. The one or more computer-readable storage media of claim 8, wherein each input record is hashed using a hashing algorithm, and
wherein the data structure comprises a bloom filter.

15. A computer system comprising one or more computer processors configured to perform operations comprising:
processing, using a first encryption key generated for one or more computer processors, a first plurality of input records to generate a first plurality of encrypted records partitioned into a plurality of groups, each group including one or more encrypted records having a group prefix, each group of encrypted records stored on a data repository and keyed using the group prefix;
receiving, from a second device, a second plurality of encrypted records, each encrypted based on a second encryption key generated for the second device, and accompanied by a prefix provided by the second device:
encrypting the second plurality of encrypted records based on the first encryption key to create a second plurality of doubly encrypted records;
querying, using the prefix provided by the second device as a database key, the data repository to fetch a group of encrypted records;
generating a data structure encoded to indicate a presence of each encrypted record of the group of encrypted records fetched from the data repository; and
transmitting the second plurality of doubly encrypted records and the data structure to the second device, the second device using the second plurality of doubly encrypted records and the data structure to determine whether at least one of the second plurality of encrypted records is included in one group of the plurality of groups of encrypted records.

16. The computer system of claim 15, wherein the data repository comprises one or more databases configured to conduct transactions using an append-only file persistence mechanism.

17. The computer system of claim 16, wherein the operations further comprise:
capturing live updates to the first plurality of input records using at least one data pipeline coupled to the one or more databases of the data repository, wherein the at least one data pipeline is driven by a distributed publish-subscribe messaging protocol.

18. The computer system of claim 17, wherein the operations further comprise:
streaming the live updates to the one or more databases at the data repository via the at least one data pipeline.

19. The computer system of claim 17, wherein the operations further comprise:
incorporating information from at least one offline database by executing one or more batch jobs to backfill the one or more databases of the data repository based on the information from the at least one offline database.

20. The computer system of claim 19, wherein the operations further comprise:
responsive to a portion of the information from the at least one offline database being invalid, transmitting an alert to the at least one offline database without incorporating the portion of the information in the one or more databases of the data repository.
